(19) United States
(12) Patent Application Publication
(10) Pub. No.: US 2008/0186638 A1
(43) Pub. Date: Aug. 7, 2008

(54) TUNNELING MAGNETIC SENSING ELEMENT HAVING FREE MAGNETIC LAYER INSERTED WITH NONMAGNETIC METAL LAYERS

(76) Inventors: Kazumasa Nishimura, Niigata-ken (JP); Ryo Nakabayashi, Niigata-ken (JP); Hidekazu Kobayashi, Niigata-ken (JP); Yoshihiro Nishiyama, Niigata-ken (JP); Yosuke Ide, Niigata-ken (JP); Masamichi Saito, Niigata-ken (JP); Naoya Hasegawa, Niigata-ken (JP)

Correspondence Address: BRINKS HOFER GILSON & LIONE, P.O. BOX 10395, CHICAGO, IL, 60610, US

(21) Appl. No.: 12/026,329

(22) Filed: Feb. 5, 2008

(30) Foreign Application Priority Data
Feb. 5, 2007 (JP) 2007-025681

(51) Int. Cl. G11B 5/33

(52) U.S. Cl. 360/324.2

(57) ABSTRACT

A tunneling magnetic sensing element includes a free magnetic layer disposed on an insulating barrier layer, the free magnetic layer including an enhancement layer, a first soft magnetic layer, a first nonmagnetic metal layer, a second soft magnetic layer, a second nonmagnetic metal layer, and a third soft magnetic layer disposed in that order from the bottom. The enhancement layer is, for example, composed of Co—Fe, each of the soft magnetic layers is, for example, composed of Ni—Fe, and each of the nonmagnetic metal layers is, for example, composed of Ta. Consequently, it is possible to stably obtain a high rate of change in resistance (ΔR/R) compared with the known art.

### CLAIM OF PRIORITY

This application claims benefit of the Japanese Patent Application No. 2007-025681 filed on Feb. 5, 2007, the entire content of which is hereby incorporated by reference.

### BACKGROUND OF THE INVENTION

1. Field of the Invention

The present invention relates to magnetic sensing elements which utilize a tunneling effect and which are to be mounted on hard disk drives and other magnetic sensing devices. More particularly, the invention relates to a tunneling magnetic sensing element in which the rate of change in resistance (ΔR/R) can be increased.

2. Description of the Related Art

In a tunneling magnetic sensing element (TMR element), the change in resistance is caused by a tunneling effect. When the magnetization direction of a pinned magnetic layer is antiparallel to the magnetization direction of a free magnetic layer, a tunnel current does not easily flow through an insulating barrier layer (tunnel barrier layer) provided between the pinned magnetic layer and the free magnetic layer, and the resistance is at a maximum. On the other hand, when the magnetization direction of the pinned magnetic layer is parallel to the magnetization direction of the free magnetic layer, the tunnel current flows easily, and the resistance is at a minimum.

By use of the principle described above, a change in electrical resistance caused by a variation in the magnetization of the free magnetic layer under an influence of an external magnetic field is captured as a change in voltage, and thus a leakage magnetic field from a recording medium is detected. Examples of the related art include Japanese Unexamined Patent Application Publication No. 2006-261637 (Patent Document 1).

Patent Document 1 discloses a tunneling magnetoresistance element including a free magnetic layer having a laminated ferrimagnetic structure.

In the invention according to Patent Document 1, in order to generate a sufficiently large exchange coupling between ferromagnetic layers constituting the free magnetic layer, a first orientation control buffer layer is disposed in the ferromagnetic layers. For example, column [0139] of Patent Document 1 discloses an example in which a free magnetic layer has a structure including Ni₈₁Fe₁₉(2 nm)/Ta(0.4 nm)/Ni₈₁Fe₁₉(2 nm)/Ru(2.1 nm)/Ni₈₁Fe₁₉(4 nm) disposed in that order from the bottom.

However, the invention according to Patent Document 1 does not describe a structure in which the rate of change in resistance (ΔR/R) is increased.

### SUMMARY

The present invention provides a tunneling magnetic sensing element in which the rate of change in resistance (ΔR/R) can be increased.

A tunneling magnetic sensing element according to the present invention includes a laminate including a pinned magnetic layer whose magnetization direction is pinned, an insulating barrier layer, and a free magnetic layer whose magnetization direction varies in response to an external magnetic field disposed in that order from the bottom, or a laminate including the free magnetic layer, the insulating barrier layer, and the pinned magnetic layer disposed in that order from the bottom. The free magnetic layer includes three or more soft magnetic layers; two or more nonmagnetic metal layers, each nonmagnetic metal layer being disposed between two adjacent soft magnetic layers; and an enhancement layer disposed between a first soft magnetic layer and the insulating barrier layer and having higher spin polarizability than each of the soft magnetic layers, the first soft magnetic layer corresponding to one of the soft magnetic layers being provided closest to the insulating barrier layer. Each nonmagnetic metal layer has a thickness that allows the two adjacent soft magnetic layers to be magnetically coupled to each other and allows all the soft magnetic layers to be magnetized in the same direction.

In the present invention, a nonmagnetic metal layer is disposed between each two adjacent soft magnetic layers constituting a free magnetic layer. The number of soft magnetic layers is three or more, and the number of nonmagnetic metal layers is two or more. Thereby, it is possible to effectively increase the rate of change in resistance (ΔR/R) compared with the known art. According to the experiments which will be described later, in the tunneling magnetic sensing element of the present invention, it is possible to obtain substantially the same RA (element resistance R×area A) as a conventional example in which the nonmagnetic metal layers are not provided in the free magnetic layer or a comparative example in which only one nonmagnetic metal layer is provided between the soft magnetic layers of the free magnetic layer, and a larger rate of change in resistance (ΔR/R) than the conventional example or the comparative example.

Unlike Patent Document 1, in the present invention, the free magnetic layer does not have a laminated ferrimagnetic structure. If the free magnetic layer has a laminated ferrimagnetic structure, for example, the antiparallel magnetization directions of two magnetic layers facing each other with a nonmagnetic intermediate layer therebetween are disturbed due to a unidirectional bias magnetic field from a hard bias layer placed at each side in the track width direction of the free magnetic layer, and Barkhausen noise is easily caused. Furthermore, although the coercive force of the free magnetic layer is preferably as small as possible, if the free magnetic layer has a laminated ferrimagnetic structure, the coercive force tends to increase.

In the present invention, preferably, each nonmagnetic metal layer has an average thickness of 1 to 4 Å. In such a case, the soft magnetic layers can be properly magnetically coupled to each other, a high rate of change in resistance (ΔR/R) can be maintained. It is also possible to improve stability in reproducing characteristics, for example, Barkhausen noise can be appropriately suppressed.

In the present invention, preferably, each nonmagnetic metal layer is composed of at least one of Ti, V, Zr, Nb, Mo, Hf, Ta, and W. More preferably, each nonmagnetic metal layer is composed of Ta. In such a case, it is possible to effectively increase the rate of change in resistance (ΔR/R).

In the present invention, preferably, the total thickness obtained by adding the average thickness of the first soft magnetic layer and the average thickness of the enhancement layer is 25 to 80 Å. In such a case, it is possible to effectively increase the rate of change in resistance (ΔR/R).

In the present invention, preferably, each soft magnetic layer has an average thickness of 10 to 30 Å. In such a case, it is possible to effectively increase the rate of change in resistance (ΔR/R). It is also possible to expect a decrease in Barkhausen noise and improvement in the S/N ratio.

In the present invention, preferably, the total thickness obtained by adding the average thicknesses of the individual soft magnetic layers is 35 to 80 Å.

In the present invention, preferably, the insulating barrier layer is composed of Ti—Mg—O. In such a case, it is possible to effectively increase the rate of change in resistance (ΔR/R).

In the present invention, preferably, each soft magnetic layer is composed of a Ni—Fe alloy, and the enhancement layer is composed of a Co—Fe alloy from the standpoint of effectively increasing the rate of change in resistance (ΔR/R).

In the tunneling magnetic sensing element of the present invention, it is possible to increase the rate of change in resistance (ΔR/R) compared with the related art.

### BRIEF DESCRIPTION OF THE DRAWINGS

FIG. 1 is a cross-sectional view of a tunneling magnetic sensing element, taken along a plane parallel to a surface facing a recording medium;

FIG. 2 is a partially enlarged cross-sectional view of the tunneling magnetic sensing element shown in FIG. 1 according to a first embodiment;

FIG. 3 is a partially enlarged cross-sectional view of a tunneling magnetic sensing element according to a second embodiment including a free magnetic layer having a different structure from that shown in FIG. 2;

FIG. 4 is a partially enlarged cross-sectional view of a tunneling magnetic sensing element according to a third embodiment including a free magnetic layer having a different structure from that shown in FIG. 2;

FIG. 5 is a cross-sectional view illustrating a step in a method for manufacturing a tunneling magnetic sensing element, taken along the same plane as FIG. 1;

FIG. 6 is a cross-sectional view illustrating a step subsequent to the step shown in FIG. 5;

FIG. 7 is a cross-sectional view illustrating a step subsequent to the step shown in FIG. 6;

FIG. 8 is a cross-sectional view illustrating a step subsequent to the step shown in FIG. 7;

FIG. 9 is a graph showing the relationship between RA and the rate of change in resistance (ΔR/R) with respect to Example 1 in which two nonmagnetic metal layers are provided in soft magnetic layers of a free magnetic layer, Comparative Example 1 in which one nonmagnetic metal layer is provided in soft magnetic layers of a free magnetic layer, and Conventional Example in which no nonmagnetic metal layer is provided in a free magnetic layer; and

FIG. 10 is a graph showing the relationship between the total thickness obtained by adding the average thickness of a first soft magnetic layer and the average thickness of an enhancement layer and the rate of change in resistance (ΔR/R) with respect to a tunneling magnetoresistance element in which two nonmagnetic metal layers are inserted between soft magnetic layers constituting a free magnetic layer and an enhancement layer is provided (Example 2), and a tunneling magnetoresistance element in which two nonmagnetic metal layers are inserted between soft magnetic layers constituting a free magnetic layer, but no enhancement layer is provided (Comparative Example 2).

### DESCRIPTION OF THE EMBODIMENTS

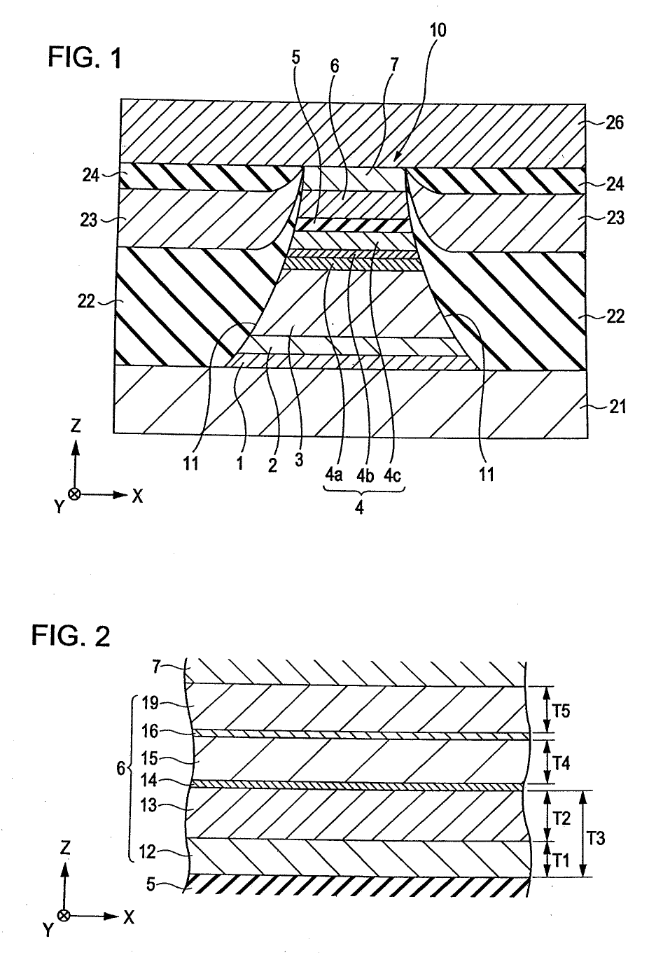

FIG. 1 is a cross-sectional view of a tunneling magnetic sensing element according to a first embodiment of the present disclosure, taken along a plane parallel to a surface facing a recording medium. FIG. 1 mainly illustrates an overall structure of the tunneling magnetic sensing element. FIG. 2 is a partially enlarged cross-sectional view of the tunneling magnetic sensing element shown in FIG. 1, and illustrates a structure of a free magnetic layer, which is a characteristic part of this embodiment.

A tunneling magnetic sensing element is, for example, mounted on the trailing end of a floating-type slider provided on a hard disk drive to detect a leakage magnetic field (recorded magnetic field) from a magnetic recording medium. In the drawings, the X direction corresponds to the track width direction, the Y direction corresponds to the direction of a leakage magnetic field from a magnetic recording medium (height direction), and the Z direction corresponds to the travelling direction of the magnetic recording medium and the lamination direction of the individual layers in the tunneling magnetic sensing element.

Referring to FIG. 1, a lower shield layer 21, for example, composed of a Ni—Fe alloy, is disposed at the bottom. A laminate 10 is disposed on the lower shield layer 21. The tunneling magnetic sensing element includes the laminate 10, and lower insulating layers 22, hard bias layers 23, and upper insulating layers 24 disposed at both sides in the track width direction (in the X direction) of the laminate 10.

The bottom layer in the laminate 10 is an underlying layer 1 composed of one or two or more nonmagnetic elements selected from the group consisting of Ta, Hf, Nb, Zr, Ti, Mo, and W. A seed layer 2 is disposed on the underlying layer 1. The seed layer 2 is composed of Ni—Fe—Cr or Cr. Note that the underlying layer 1 may be omitted.

An antiferromagnetic layer 3 disposed on the seed layer 2 is preferably composed of an antiferromagnetic material containing X and Mn, wherein X is one or two or more elements selected from the group consisting of Pt, Pd, Ir, Rh, Ru, and Os.

The antiferromagnetic layer 3 may be composed of an antiferromagnetic material containing X, X′, and Mn, wherein X′ is one or two or more elements selected from the group consisting of Ne, Ar, Kr, Xe, Be, B, C, N, Mg, Al, Si, P, Ti, V, Cr, Fe, Co, Ni, Cu, Zn, Ga, Ge, Zr, Nb, Mo, Ag, Cd, Sn, Hf. Ta, W, Re, Au, Pb, and rare-earth elements. The antiferromagnetic layer 3 is, for example, composed of Ir—Mn.

A pinned magnetic layer 4 is disposed on the antiferromagnetic layer 3. The pinned magnetic layer 4 has a laminated ferrimagnetic structure in which a first pinned magnetic sublayer 4a, a nonmagnetic intermediate sublayer 4b, and a second pinned magnetic sublayer 4c are disposed in that order from the bottom. The magnetizations of the first pinned magnetic sublayer 4a and the second pinned magnetic sublayer 4c are directed antiparallel to each other by an exchange coupling magnetic field (Hex) at the interface with the antiferromagnetic layer 3 and by an antiferromagnetic exchange coupling magnetic field (RKKY interaction) through the nonmagnetic intermediate sublayer 4b. By forming the pinned magnetic layer 4 so as to have such a laminated ferrimagnetic structure, the magnetization of the pinned magnetic layer 4 can be stabilized. Furthermore, the apparent exchange coupling magnetic field generated at the interface between the pinned magnetic layer 4 and the antiferromagnetic layer 3 can be increased. Each of the first pinned magnetic sublayer 4a and the second pinned magnetic sublayer 4c has a thickness of about 10 to 40 Å, and the nonmagnetic intermediate sublayer 4b has a thickness of about 8 to 10 Å.

Each of the first pinned magnetic sublayer 4a and the second pinned magnetic sublayer 4c is composed of a ferromagnetic material, such as Co—Fe, Ni—Fe, or Co—Fe—Ni. The nonmagnetic intermediate sublayer 4b is composed of a nonmagnetic conductive material, such as Ru, Rh, Ir, Cr, Re, or Cu.

An insulating barrier layer 5 is disposed on the pinned magnetic layer 4. A free magnetic layer 6 is disposed on the insulating barrier layer 5. The structure of the free magnetic layer 6 will be described later.

The width in the track width direction (in the X direction) of the free magnetic layer 6 defines the track width Tw.

A protective layer 7 is disposed on the free magnetic layer 6. The protective layer 7 is composed of a nonmagnetic metal material and may have a single-layer structure or a multilayered structure. For example, the protective layer 7 has a single-layer structure composed of Ta or a multilayered structure composed of Ru/Ta.

Each side face 11 in the track width direction (in the X direction) of the laminate 10 is formed as an inclined plane such that the width in the track width direction gradually decreases upward.

As shown in FIG. 1, a lower insulating layer 22 is disposed on the lower shield layer 21 extending at each side of the laminate 10 so as to be in contact with each side face 11 of the laminate 10. A hard bias layer 23 is disposed on the lower insulating layer 22, and an upper insulating layer 24 is disposed on the hard bias layer 23.

A bias underlying layer (not shown) may be disposed between the lower insulating layer 22 and the hard bias layer 23. The bias underlying layer is composed of, for example, Cr, W, or Ti.

Each of the insulating layers 22 and 24 is composed of an insulating material, such as Al₂O₃ or SiO₂. The insulating layers 24 and 22 insulate the upper and lower surfaces of the hard bias layer 23 so that a current flowing in the laminate 10 perpendicular to the interfaces between the individual layers is prevented from shunting from each side of the laminate 10. The hard bias layer 23 is composed of, for example, a cobalt-platinum (Co—Pt) alloy, a cobalt-chromium-platinum (Co—Cr—Pt) alloy, or the like.

An upper shield layer 26 composed of a Ni—Fe alloy or the like is disposed over the laminate 10 and the upper insulating layers 24.

In the embodiment shown in FIG. 1, the lower shield layer 21 and the upper shield layer 26 serve as electrode layers for the laminate 10. A current is made to flow perpendicular to the planes of the individual layers constituting the laminate 10 (in a direction parallel to the Z direction).

The free magnetic layer 6 is magnetized in a direction parallel to the track width direction (the X direction) under the influence of a bias magnetic field from the hard bias layer 23. On the other hand, each of the first pinned magnetic sublayer 4a and the second pinned magnetic sublayer 4c constituting the pinned magnetic layer 4 is magnetized in a direction parallel to the height direction (the Y direction). Since the pinned magnetic layer 4 has the laminated ferrimagnetic structure, the first pinned magnetic sublayer 4a and the second pinned magnetic sublayer 4c are magnetized antiparallel to each other. While the magnetization of the pinned magnetic layer 4 is pinned (does not vary in response to an external magnetic field), the magnetization of the free magnetic layer 6 varies in response to an external magnetic field.

When the magnetization of the free magnetic layer 6 varies in response to an external magnetic field and when the magnetization directions of the second pinned magnetic sublayer 4c and the free magnetic layer 6 are antiparallel to each other, a tunnel current does not easily flow through the insulating barrier layer 5 provided between the second pinned magnetic sublayer 4c and the free magnetic layer 6, and the resistance is at a maximum. On the other hand, when the magnetization directions of the second pinned magnetic sublayer 4c and the free magnetic layer 6 are parallel to each other, the tunnel current flows most easily, and the resistance is at a minimum.

By use of the principle described above, a change in electrical resistance caused by a variation in the magnetization of the free magnetic layer 6 under an influence of an external magnetic field is captured as a change in voltage, and thus a leakage magnetic field from a magnetic recording medium is detected.

The characteristic part of the tunneling magnetic sensing element according to this embodiment will be described below. As shown in FIG. 2, the free magnetic layer 6 includes an enhancement layer 12, a first soft magnetic layer 13, a first nonmagnetic metal layer 14, a second soft magnetic layer 15, a second nonmagnetic metal layer 16, and a third soft magnetic layer 19 disposed in that order from the bottom.

The enhancement layer 12 is composed of a magnetic material having higher spin polarizability than each of the first soft magnetic layer 13, the second soft magnetic layer 15, and the third soft magnetic layer 19. Preferably, the enhancement layer 12 is composed of a Co—Fe alloy. It has been known that if the enhancement layer 12 is not disposed, the rate of change in resistance (ΔR/R) is greatly decreased. Therefore, the enhancement layer 12 is an essential layer. By increasing the Fe content in the Co—Fe alloy constituting the enhancement layer 12, it is possible to obtain a high rate of change in resistance (ΔR/R). The Fe content in the Co—Fe alloy is preferably in a range of 50 to 100 atomic percent.

Each of the first soft magnetic layer 13, the second soft magnetic layer 15, and the third soft magnetic layer 19 is composed of a material that has excellent soft magnetic properties, such as a lower coercive force and a lower anisotropic magnetic field than the enhancement layer 12. The first soft magnetic layer 13, the second soft magnetic layer 15, and the third soft magnetic layer 19 may be composed of different soft magnetic materials, but preferably are each composed of a Ni—Fe alloy. The Fe content in the Ni—Fe alloy is preferably in a range of 5 to 20 atomic percent.

Each of the first nonmagnetic metal layer 14 and the second nonmagnetic metal layer 16 is composed of at least one nonmagnetic metal material selected from the group consisting of Ti, V, Zr, Nb, Mo, Hf. Ta, and W. When two or more nonmagnetic metal materials are selected, each of the first nonmagnetic metal layer 14 and the second nonmagnetic metal layer 16 is, for example, composed of an alloy, or formed so as to have a layered structure including layers composed of the individual nonmagnetic metal materials.

In this embodiment, preferably, each of the first nonmagnetic metal layer 14 and the second nonmagnetic metal layer 16 is composed of Ta.

Each of the first nonmagnetic metal layer 14 and the second nonmagnetic metal layer 16 is formed with a small thickness so that the first soft magnetic layer 13 and the second soft magnetic layer 15 are magnetically coupled to each other and the second soft magnetic layer 15 and the third soft magnetic layer 19 are magnetically coupled to each other, and so that the first soft magnetic layer 13, the second soft magnetic layer 15, and the third soft magnetic layer 19 are magnetized in the same direction. For example, the first soft magnetic layer 13, the second soft magnetic layer 15, and the third soft magnetic layer 19 are each magnetized in the X direction. In such a case, the enhancement layer 12 is also magnetized in the X direction.

Specifically, the average thickness of each of the first nonmagnetic metal layer 14 and the second nonmagnetic metal layer 16 is preferably 1 to 4 Å. If the average thickness of each of the first nonmagnetic metal layer 14 and the second nonmagnetic metal layer 16 is smaller than 1 Å, it is not possible to obtain the effect of increasing the rate of change in resistance (ΔR/R). If the average thickness of each of the first nonmagnetic metal layer 14 and the second nonmagnetic metal layer 16 is larger than 4 Å, magnetic coupling between the first soft magnetic layer 13 and the second soft magnetic layer 15 and magnetic coupling between the second soft magnetic layer 15 and the third soft magnetic layer 19 are easily broken, and reproducing characteristics become unstable, for example, Barkhausen noise easily occurs. Consequently, in this embodiment, the average thickness of each of the first nonmagnetic metal layer 14 and the second nonmagnetic metal layer 16 is preferably 1 to 4 Å. More preferably, the average thickness of each of the first nonmagnetic metal layer 14 and the second nonmagnetic metal layer 16 is 1 to 2 Å.

As described above, the average thickness of each of the first nonmagnetic metal layer 14 and the second nonmagnetic metal layer 16 is very small. Consequently, the first nonmagnetic metal layer 14 and the second nonmagnetic metal layer 16 may be intermittently formed on the first soft magnetic layer 13 and the second soft magnetic layer 15, respectively, instead of being formed with a predetermined thickness as shown in FIG. 2. Furthermore, by forming the first nonmagnetic metal layer 14 and the second nonmagnetic metal layer 16 intermittently, it is possible to further increase magnetic coupling (ferromagnetic coupling) between the first soft magnetic layer 13 and the second soft magnetic layer 15 and magnetic coupling between the second soft magnetic layer 15 and the third soft magnetic layer 19. Furthermore, the average thickness of each of the first nonmagnetic metal layer 14 and the second nonmagnetic metal layer 16 refers to a thickness obtained by leveling off each of the first nonmagnetic metal layer 14 and the second nonmagnetic metal layer 16 uniformly over the entire surface of the first soft magnetic layer 13 or the second soft magnetic layer 15. Consequently, when the nonmagnetic metal layers 14 and 16 are intermittently formed on the soft magnetic layers 13 and 15, respectively, the “average thickness” is set including portions (pinhole portions) at which the nonmagnetic metal layers 14 and 16 are not disposed on the soft magnetic layers 13 and 15, respectively.

In this embodiment, as described above, two or more nonmagnetic metal layers, i.e., the nonmagnetic metal layers 14 and 16, are inserted at a certain distance from each other in the thickness direction (in the Z direction), between the soft magnetic layers constituting the free magnetic layer 6.

Consequently, it is possible to effectively increase the rate of change in resistance (ΔR/R) compared with a conventional example in which the nonmagnetic metal layers 14 and 16 are not provided in the free magnetic layer 6, or a comparative example in which only one nonmagnetic metal layer is provided between the soft magnetic layers of the free magnetic layer 6. In this case, the RA (element resistance R×area A) can be set to be substantially the same as that in the conventional example or the comparative example, and the variation in RA can be reduced as much as possible. In this embodiment, preferably, the RA is 2 to 3 Ω·μm².

The reason for the increase in the rate of change in resistance (ΔR/R) is considered to be that the nonmagnetic metal layers 14 and 16 preferentially chemically bond to oxygen atoms which are diffused from the insulating barrier layer 5 into the soft magnetic layers 13, 15, and 19 and the enhancement layer 12, the oxygen contents in the soft magnetic layers 13, 15, and 19 and in the enhancement layer 12 are decreased, and as a result, proper band structures of the soft magnetic layers 13, 15, and 19 and the enhancement layer 12 are achieved, thus improving spin polarizability. Another reason is considered to be that, by providing two or more nonmagnetic metal layers, i.e., the nonmagnetic metal layers 14 and 16, the thickness of each of the soft magnetic layers 13, 15, and 19 is decreased, and crystal growth is suppressed, resulting in a decrease in the crystal grain diameter of each of the soft magnetic layers 13, 15, and 19. Furthermore, changes occur in stress applied to the interface with the insulating barrier layer 5 and lattice strain, resulting in improvement in the spin polarizability at the interface.

As described above, by providing two or more nonmagnetic metal layers, i.e., the nonmagnetic metal layers 14 and 16, the thickness of each of the soft magnetic layers 13, 15, and 19 is decreased, and the crystal grain diameter of each of the soft magnetic layers 13, 15, and 19 is decreased. As a result, even if the element size is refined as the recording density is increased, it is possible to suppress the variation in the magnetic moment among crystal grains. Consequently, Barkhausen noise can be suppressed, and the S/N ratio can be improved.

In this embodiment, the insulating barrier layer 5 is preferably composed of magnesium titanate (Ti—Mg—O). The Mg content is preferably 4 to 20 atomic percent when the compositional ratio of Ti and Mg in total is 100 atomic percent. In such a case, it is possible to effectively increase the rate of change in resistance (ΔR/R). Besides Ti—Mg—O, the insulating barrier layer 5 may be composed of, for example, titanium oxide (Ti—O), aluminum oxide (Al—O), or magnesium oxide (Mg—O).

As shown in FIG. 2, T1 represents the average thickness of the enhancement layer 12; T2 represents the average thickness of the first soft magnetic layer 13; T4 represents the average thickness of the second soft magnetic layer 15; and T5 represents the average thickness of the third soft magnetic layer 19. T3 represents the total thickness obtained by adding the average thickness T1 of the enhancement layer 12 and the average thickness T2 of the first soft magnetic layer 13.

In this embodiment, preferably, the total thickness T3 is 25 to 80 Å. Consequently, the first nonmagnetic metal layer 14 is formed at a distance of 25 Å or more from the insulating barrier layer 5. Even if the total thickness T3 is set to be more than 80 Å, the effect of increasing the rate of change in resistance (ΔR/R) cannot be expected. By setting the total thickness T3 at 25 to 80 Å, it is possible to stably obtain a high rate of change in resistance (ΔR/R). The total thickness T3 is more preferably 60 Å or less.

Preferably, the average thicknesses T2, T4, and T5 of the soft magnetic layers 13, 15, and 19, respectively, are each 10 to 30 Å. In such a case, it is possible to expect the effect of increasing the rate of change in resistance (ΔR/R), the effect of decreasing Barkhausen noise, and the effect of improving the S/N ratio.

Furthermore, the total thickness obtained by adding the average thicknesses T2, T4, and T5 of the soft magnetic layers 13, 15, and 19 is preferably 35 to 80 Å. In such a case, it is possible to stably obtain a high rate of change in resistance (ΔR/R).

Preferably, the average thickness T1 of the enhancement layer 12 is 10 to 30 Å. In such a case, it is possible to stably obtain a high rate of change in resistance (ΔR/R).

In the embodiment shown in FIGS. 1 and 2, an antiferromagnetic layer 3, a pinned magnetic layer 4, an insulating barrier layer 5, a free magnetic layer 6, and a protective layer 7 are disposed in that order from the bottom. However, a free magnetic layer 20, an insulating barrier layer 5, a pinned magnetic layer 4, an antiferromagnetic layer 3, and a protective layer 7 may be disposed in that order from the bottom.

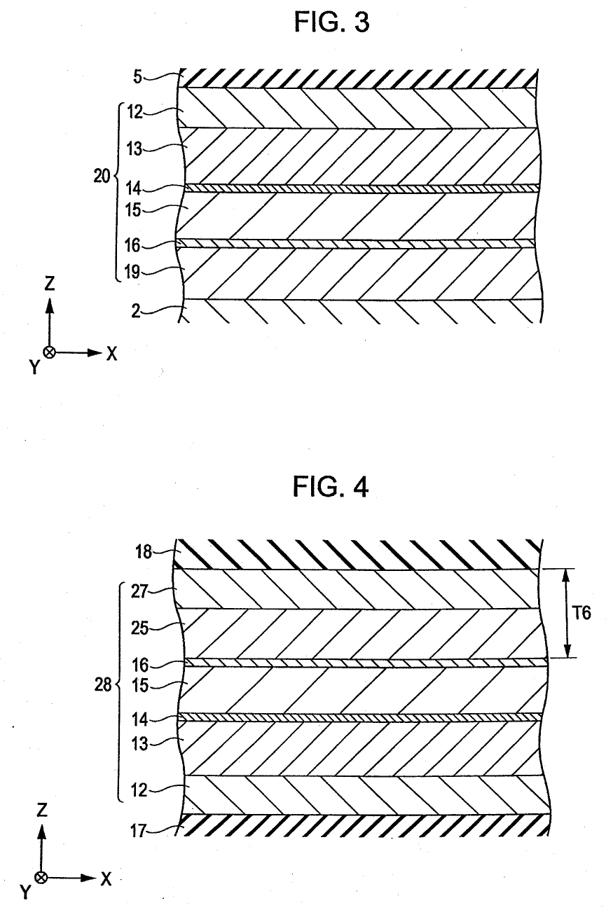

In such a case, as shown in FIG. 3 (second embodiment), the free magnetic layer 20 includes a third soft magnetic layer 19, a second nonmagnetic metal layer 16, a second soft magnetic layer 15, a first nonmagnetic metal layer 14, a first soft magnetic layer 13, and an enhancement layer 12 disposed in that order from the bottom, and the insulating barrier layer 5 is disposed on the free magnetic layer 20. The thickness and the material of each of the layers constituting the free magnetic layer 20 are the same as those of the free magnetic layer 6 described with reference to FIG. 2.

Alternatively, a dual-type tunneling magnetic sensing element may be used in which a lower antiferromagnetic layer, a lower pinned magnetic layer, a lower insulating barrier layer, a free magnetic layer, an upper insulating barrier layer, an upper pinned magnetic layer, and an upper antiferromagnetic layer are disposed in that order from the bottom.

In such a case, as shown in FIG. 4 (third embodiment), a free magnetic layer 28 includes an enhancement layer 12, a first soft magnetic layer 13, a first nonmagnetic metal layer 14, a second soft magnetic layer 15, a second nonmagnetic metal layer 16, a first soft magnetic layer 25, and an enhancement layer 27 disposed in that order from the bottom. The lower insulating barrier layer 17 is disposed under the lower enhancement layer 12 of the free magnetic layer 28, and the upper insulating barrier layer 18 is disposed on the upper enhancement layer 27 of the free magnetic layer 28. The thickness and the material of each of the layers constituting the free magnetic layer 28 are the same as those of the free magnetic layer 6 described with reference to FIG. 2.

In the case shown in FIG. 4, preferably, the total thickness T6 obtained by adding the average thickness of the upper enhancement layer 27 and the average thickness of the first soft magnetic layer 25 is also set at 25 to 80 Å as in the total thickness T3 obtained by adding the average thickness of the lower enhancement layer 12 and the average thickness of the first soft magnetic layer 13.

In each of the embodiments shown in FIGS. 2 to 4, the number of nonmagnetic layers inserted between the soft magnetic layers of the free magnetic layer 6, 20, or 28 is two. However, three or more nonmagnetic metal layers may be inserted. However, even if the number of nonmagnetic metal layers is excessively increased, it is not possible to expect the effect of increasing the rate of change in resistance (ΔR/R), and there is a possibility that the other properties, such as the RA, are affected. Moreover, the manufacturing process becomes complicated. Therefore, the number of nonmagnetic metal layers is preferably about eight at a maximum.

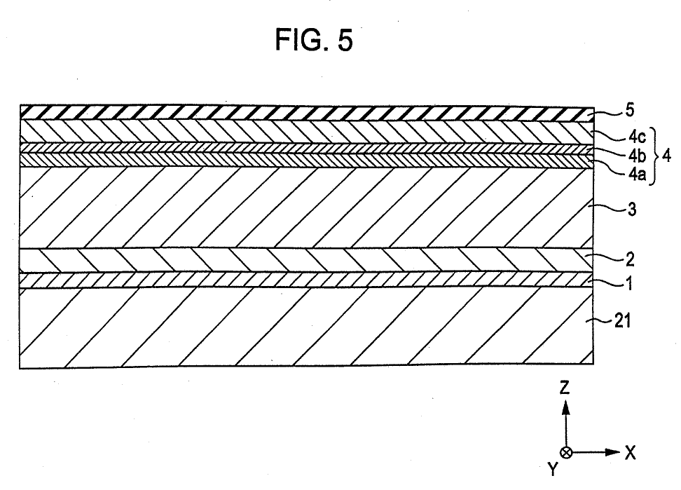

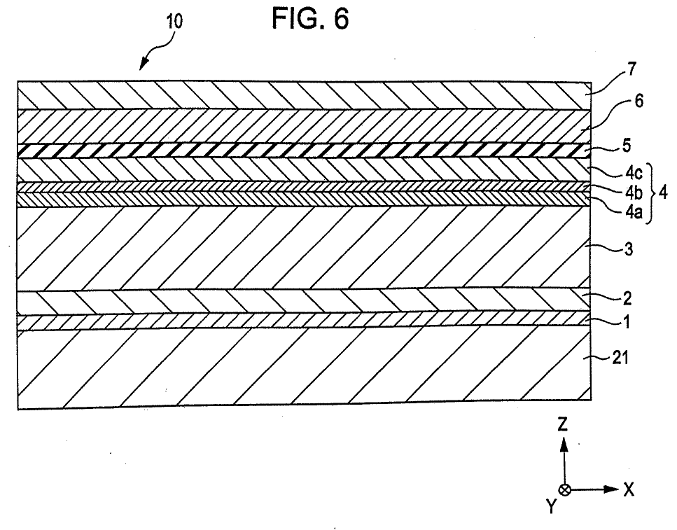

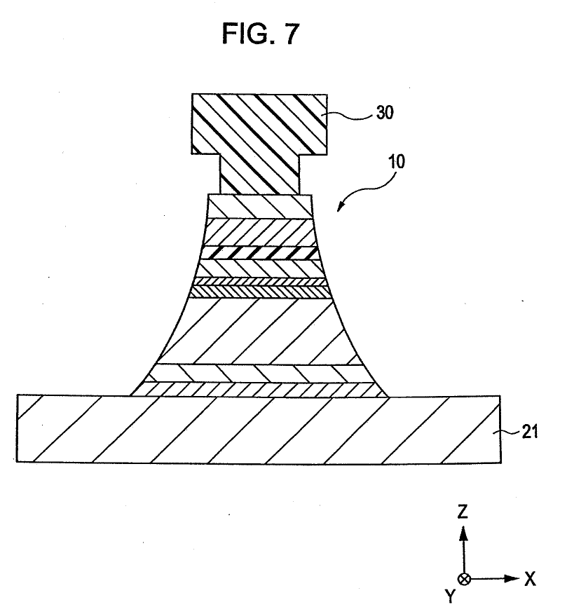

A method for manufacturing the tunneling magnetic sensing element according to the first embodiment will be described below. FIGS. 5 to 8 are each a partial cross-sectional view of the tunneling magnetic sensing element in a manufacturing step, taken along the same plane as FIG. 1. In FIGS. 6 to 8, although the free magnetic layer appears to have a single-layer structure, actually, the free magnetic layer is formed so as to have the structure shown in FIG. 2.

In the step shown in FIG. 5, an underlying layer 1, a seed layer 2, an antiferromagnetic layer 3, a first pinned magnetic sublayer 4a, a nonmagnetic intermediate sublayer 4b, and a second pinned magnetic sublayer 4c are continuously formed in that order from the bottom on a lower shield layer 21.

Subsequently, an insulating barrier layer 5 is formed on the second pinned magnetic sublayer 4c. For example, the insulating barrier layer 5 is composed of Ti—Mg—O. The insulating barrier layer 5 composed of Ti—Mg—O is obtained, for example, by a method in which, first, a Ti layer is formed by sputtering on the second pinned magnetic sublayer 4c, a Mg layer is formed by sputtering on the Ti layer, and then the Ti layer and the Mg layer are subjected to oxidation. Besides Ti—Mg—O, for example, Ti—O, Al—O, or Mg—O may be used for the insulating barrier layer 5.

Subsequently, as shown in FIG. 6, a free magnetic layer 6 and a protective layer 7 are formed on the insulating barrier layer 5.

In this embodiment, as shown in FIG. 2, the free magnetic layer 6 has a layered structure including an enhancement layer 12, a first soft magnetic layer 13, a first nonmagnetic metal layer 14, a second soft magnetic layer 15, a second nonmagnetic metal layer 16, and a third soft magnetic layer 19 formed in that order from the bottom. Preferably, the enhancement layer 12 is composed of a Co—Fe alloy, each of the first soft magnetic layer 13, the second soft magnetic layer 15, and the third soft magnetic layer 19 is composed of a Ni—Fe alloy, and each of the first nonmagnetic metal layer 14 and the second nonmagnetic metal layer 16 is composed of Ta.

Furthermore, as described with reference to FIG. 2, each of the first nonmagnetic metal layer 14 and the second nonmagnetic metal layer 16 is formed so as to have a very small thickness, with an average thickness or 1 to 4 Å. Thereby, the first soft magnetic layer 13 and the second soft magnetic layer 15 can be magnetically coupled to each other, the second soft magnetic layer 15 and the third soft magnetic layer 19 can be magnetically coupled to each other, and the first soft magnetic layer 13, the second soft magnetic layer 15, and the third soft magnetic layer 19 can be magnetized in the same direction. With respect to the preferred ranges of the average thicknesses T2, T4, and T5 of the soft magnetic layers, the average thickness T1 of the enhancement layer 12, and the total thickness T3, refer to the descriptions made above with reference to FIG. 2. In such a manner, a laminate 10 in which layers from the underlying layer 1 to the protective layer 7 are stacked is obtained.

Subsequently, a resist layer 30 for lift-off processing is formed on the laminate 10, and then both side regions in the track width direction (in the X direction) of the laminate 10 not covered with the resist layer 30 for lift-off processing are removed by etching or the like (refer to FIG. 7).

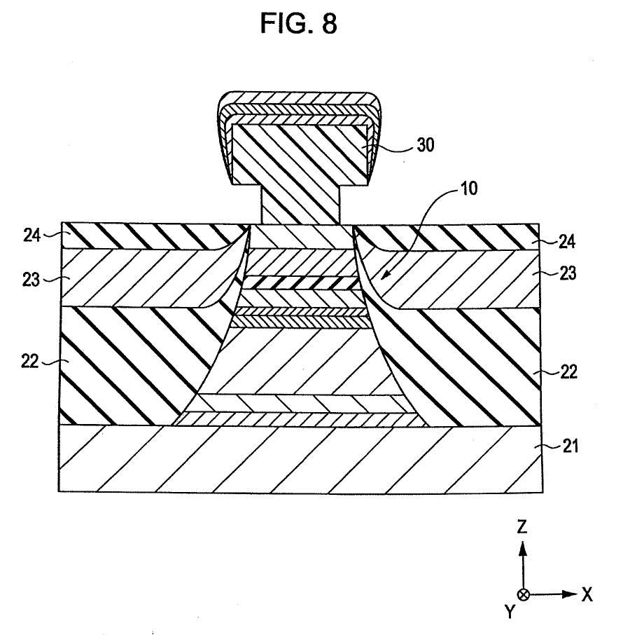

Subsequently, a lower insulating layer 22, a hard bias layer 23, and an upper insulating layer 24 are deposited in that order, at each side in the track width direction (in the X direction) of the laminate 10, on the lower shield layer 21 (refer to FIG. 8).

Subsequently, the resist layer 30 for lift-off processing is removed, and an upper shield layer 26 is formed over the laminate 10 and the upper insulating layers 24.

The method for manufacturing the tunneling magnetic sensing element described above includes annealing treatment after the formation of the laminate 10. Typical examples of annealing treatment include annealing treatment for producing an exchange coupling magnetic field (Hex) between the antiferromagnetic layer 3 and the first pinned magnetic sublayer 4a.

Each of the structure described with reference to FIG. 3 in which the free magnetic layer 20, the insulating barrier layer 5, and the pinned magnetic layer 4 are formed in that order from the bottom and the dual-type structure described with reference to FIG. 4 can be manufactured according to the method described with reference to FIGS. 5 to 8.

The tunneling magnetic sensing elements according to these embodiments can also be used as magnetoresistive random access memory (MRAM) and magnetic sensors, in addition to use as magnetic heads incorporated in hard disk drives.

### Example 1

A tunneling magnetic sensing element including a laminate having a free magnetic layer 6 in which nonmagnetic metal layers 14 and 16 were inserted between a first soft magnetic layer 13 and a second soft magnetic layer 15 and between the second soft magnetic layer 15 and a third soft magnetic layer 19, respectively, as shown in FIG. 2, was fabricated.

The laminate was formed by depositing, from the bottom, underlying layer 1; Ta(30)/seed layer 2; Ni_{49at %}Fe_{12at %}Cr_{39at %}(50)/antiferromagnetic layer 3; Ir_{26at %}Mn_{74at %}(70)/pinned magnetic layer 4 [first pinned magnetic sublayer 4a; Fe_{30at %}Co_{70at %} (16)/nonmagnetic intermediate sublayer 4b; Ru(8.5)/second pinned magnetic sublayer 4c; Co_{90at %}Fe_{10at %}(18)]/insulating barrier layer 5/free magnetic layer 6 [enhancement layer 12; Fe_{90at %}Co_{10at %}(10)/first soft magnetic layer 13; Ni_{88at %}Fe_{12at %}(20)/first nonmagnetic metal layer 14; Ta(2.5)/second soft magnetic layer 15; Ni_{88at %}Fe_{12at %}(20)/second nonmagnetic metal layer 16; Ta(X)/third soft magnetic layer; Ni_{88at %}Fe_{12at %}(25)]/first protective layer; Ru(10)/second protective layer; Ta(180). A numerical value in parentheses indicates the average thickness of each layer in unit of angstrom (Å).

### Comparative Example 1

A laminate was formed by depositing, from the bottom, underlying layer 1; Ta(30)/seed layer 2; Ni_{49at %}Fe_{12at %}Cr_{39at %}(50)/antiferromagnetic layer 3; Ir_{26at %}Mn_{74at %}(70)/pinned magnetic layer 4 [first pinned magnetic sublayer 4a; Fe_{30at %}Co_{70at %}(16)/nonmagnetic intermediate sublayer 4b; Ru(8.5)/second pinned magnetic sublayer 4c; Co_{90at %}Fe_{10at %}(18)]/insulating barrier layer 5/free magnetic layer 6 [enhancement layer 12; Fe_{90at %}Co_{10at %}(110)/first soft magnetic layer 13; Ni_{88at %}Fe_{12at %}(20)/first nonmagnetic metal layer 14; Ta(2.5)/second soft magnetic layer 15; Ni_{88at %}Fe_{12at %}(20)/third soft magnetic layer; Ni_{88at %}Fe_{12at %}(25)]/first protective layer; Ru(10)/second protective layer; Ta(180). A numerical value in parentheses indicates the average thickness of each layer in unit of angstrom (Å).

That is, in the structure of Comparative Example 1, only one nonmagnetic metal layer 14 is provided in the free magnetic layer 6.

### Conventional Example

A laminate was formed by depositing, from the bottom, underlying layer 1; Ta(30)/seed layer 2; Ni_{49at %}Fe_{12at %}Cr_{39at %}(50)/antiferromagnetic layer 3; Ir_{26at %}Mn_{74at %}(70)/pinned magnetic layer 4 [first pinned magnetic sublayer 4a; Fe_{30at %}Co_{70at %}(16)/nonmagnetic intermediate sublayer 4b; Ru(8.5)/second pinned magnetic sublayer 4c; Co_{90at %}Fe_{10at %}(8)]/insulating barrier layer 5/free magnetic layer 6 [enhancement layer 12; Fe_{90at %}Co_{10at %}(10)/first soft magnetic layer 13; Ni_{88at %}Fe_{12at %}(20)/second soft magnetic layer 15; Ni_{88at %}Fe_{12at %}(20)/third soft magnetic layer; Ni_{88at %}Fe_{12at %}(25)]/first protective layer; Ru(10)/second protective layer; Ta(180). A numerical value in parentheses indicates the average thickness of each layer in unit of angstrom (Å).

That is, in the structure of Conventional Example, no nonmagnetic metal layer is provided in the free magnetic layer 6.

In experiments, in each of Example 1, Comparative Example 1, and Conventional Example, the insulating barrier layer 5 composed of Ti—Mg—O was formed by depositing Ti(4.6)/Mg(0.6) in that order from the bottom and subjecting Ti and Mg to oxidation treatment. A numerical value in parentheses indicates the average thickness of each layer in unit of angstrom (Å).

After each laminate was formed, annealing treatment was performed on the laminate at 270° C. for 3 hours 40 minutes.

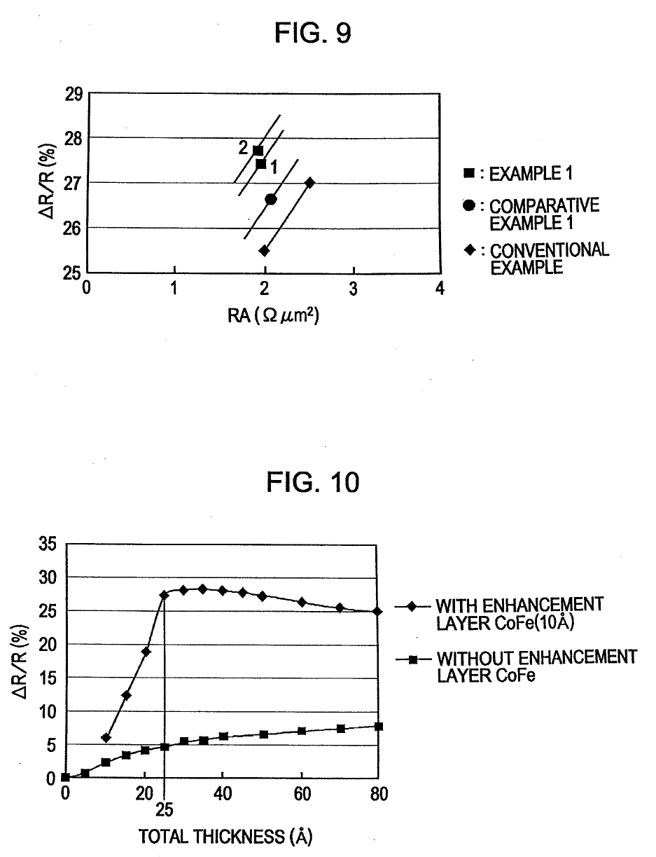

In the experiments, in Example 1, the average thickness of the second nonmagnetic metal layer 16 was changed from 1 Å to 2 Å. The rate of change in resistance (ΔR/R) in each of the tunneling magnetic sensing elements of Example 1, Comparative Example 1, and Conventional Example was measured. The experimental results are shown in a graph of FIG. 9. In the graph, a numerical value indicates the average thickness (Å) of the second nonmagnetic metal layer 16 of Example 1.

As is evident from FIG. 9, the rate of change in resistance (ΔR/R) of the tunneling magnetic sensing element of Example 1 can be effectively increased compared with the rate of change in resistance (ΔR/R) of the tunneling magnetic sensing element of Comparative Example 1 and the rate of change in resistance (ΔR/R) of the tunneling magnetic sensing element of Conventional Example. As is also evident from FIG. 9, the RA of the tunneling magnetic sensing element of Example 1 can be set substantially the same as the RA of the tunneling magnetic sensing element of Comparative Example 1, and the RA of Conventional Example.

Furthermore, as is evident from FIG. 9, in Example 1, by changing the average thickness of the second nonmagnetic metal layer 16 from 1 Å to 2 Å, a higher rate of change in resistance (ΔR/R) can be obtained. This increase is smaller than a difference in the rate of change in resistance (ΔR/R) between Comparative Example 1 in which only one nonmagnetic metal layer is provided in the free magnetic layer and Example 1 in which two nonmagnetic metal layers are provided in the free magnetic layer. That is, it has been confirmed that the effect of increasing the rate of change in resistance (ΔR/R) by providing two or more nonmagnetic metal layers in the free magnetic layer is higher than the effect of increasing the rate of change in resistance (ΔR/R) by adjusting the average thickness of the nonmagnetic metal layer.

Furthermore, the RA is preferably in the range of 2 to 3 Ω·μm². In the tunneling magnetic sensing element of Example 1, the rate of change in resistance (ΔR/R) can be effectively increased compared with the tunneling magnetic sensing element of Comparative Example 1 or Conventional Example. The RA can be adjusted, for example, by changing the oxidation time for the insulating barrier layer 5. Since one reason for the increase in the rate of change in resistance (ΔR/R) is estimated to be that the first nonmagnetic metal layer 14 and the second nonmagnetic metal layer 16 chemically bond to oxygen atoms, when the RA is substantially the same, irrespective of the RA value, in Example 1, Comparative Example 1, and Conventional Example, it is estimated to be possible to set the rate of change in resistance (ΔR/R) of the tunneling magnetic sensing element of Example 1 to be higher than the rate of change in resistance (ΔR/R) of the tunneling magnetic sensing element of Comparative Example 1 or Conventional Example.

### Example 2

A tunneling magnetic sensing element including a laminate having a free magnetic layer 6 in which nonmagnetic metal layers 14 and 16 were inserted between a first soft magnetic layer 13 and a second soft magnetic layer 15 and between the second soft magnetic layer 15 and a third soft magnetic layer 19, respectively, as shown in FIG. 2, was fabricated.

The laminate was formed by depositing, from the bottom, underlying layer 1; Ta(30)/seed layer 2; Ni_{49at %}Fe_{12at %}Cr_{39at %}(50)/antiferromagnetic layer 3; Ir_{26at %}Mn_{74at %}(70)/pinned magnetic layer 4 [first pinned magnetic sublayer 4a; Fe_{30at %}Co_{70at %}(16)/nonmagnetic intermediate sublayer 4b; Ru(8.5)/second pinned magnetic sublayer 4c; Co_{90at %}Fe_{10at %}(18)]/insulating barrier layer 5/free magnetic layer 6 [enhancement layer 12; Fe_{90at %}Co_{10at %}(10)/first soft magnetic layer 13; Ni_{88at %}Fe_{12at %}(Y)/first nonmagnetic metal layer 14; Ta(2.5)/second soft magnetic layer 15; Ni_{88at %}Fe_{12at %}(20)/second nonmagnetic metal layer 16; Ta(2)/third soft magnetic layer; Ni_{88at %}Fe_{12at %}(25)]/first protective layer; Ru(10)/second protective layer; Ta(180). A numerical value in parentheses indicates the average thickness of each layer in unit of angstrom (Å).

### Comparative Example 2

A laminate was formed by depositing, from the bottom, underlying layer 1; Ta(30)/seed layer 2; Ni_{49at %}Fe_{12at %}Cr_{39at %}(50)/antiferromagnetic layer 3; Ir_{26at %}Mn_{74at %}(70)/pinned magnetic layer 4 [first pinned magnetic sublayer 4a; Fe_{30at %}Co_{70at %}(16)/nonmagnetic intermediate sublayer 4b; Ru(8.5)/second pinned magnetic sublayer 4c; Co_{90at %}Fe_{10at %}(18)]/insulating barrier layer 5/free magnetic layer 6 [first soft magnetic layer 13; Ni_{88at %}Fe_{12at %}(Y)/first nonmagnetic metal layer 14; Ta(2.5)/second soft magnetic layer 15; Ni_{88at %}Fe_{12at %}(20)/second nonmagnetic metal layer 16; Ta(2)/third soft magnetic layer; Ni_{88at %}Fe_{12at %}(25)]/first protective layer; Ru(10)/second protective layer; Ta(180). A numerical value in parentheses indicates the average thickness of each layer in unit of angstrom (Å).

That is, in the structure of Comparative Example 2, an enhancement layer is not provided in the free magnetic layer 6.

The relationships between the total thickness obtained by adding the average thickness of the enhancement layer 12 and the average thickness of the first soft magnetic layer 13 and the rate of change in resistance (ΔR/R) was examined. In the experiment, the average thickness of the enhancement layer was fixed, and the average thickness (Y) of the first soft magnetic layer 13 was varied. The experimental results are shown in a graph of FIG. 10.

As is evident from FIG. 10, in the structure in which the enhancement layer is provided, when the total thickness is set at 25 to 80 Å, a high rate of change in resistance (ΔR/R) can be obtained stably. In contrast, in the structure (Comparative Example 2) in which the enhancement layer is not provided, even when the thickness of the first soft magnetic layer 13 (corresponding to the total thickness shown in FIG. 10) is increased, the rate of change in resistance (ΔR/R) remains low, and it has been found that the rate of change in resistance (ΔR/R) is sharply increased by the change in the thickness of the first soft magnetic layer 13.

It has been found from the experimental results shown in FIG. 10 that, when the enhancement layer 12 is provided in the free magnetic layer 6 and when the total thickness obtained by adding the average thickness of the enhancement layer 12 and the average thickness of the first soft magnetic layer 13 (i.e., the distance between the insulating barrier layer 5 and the first nonmagnetic metal layer 14) is set at 25 to 80 Å, it is possible to stably obtain a high rate of change in resistance (ΔR/R), which is preferable.

What is claimed is:

1. A tunneling magnetic sensing element comprising:
a laminate including a pinned magnetic layer whose magnetization direction is pinned, an insulating barrier layer, and a free magnetic layer whose magnetization direction varies in response to an external magnetic field disposed in that order from the bottom; or
a laminate including the free magnetic layer, the insulating barrier layer, and the pinned magnetic layer disposed in that order from the bottom,
wherein the free magnetic layer includes:
three or more soft magnetic layers;
two or more nonmagnetic metal layers, each nonmagnetic metal layer being disposed between two adjacent soft magnetic layers; and
an enhancement layer disposed between a first soft magnetic layer and the insulating barrier layer and having higher spin polarizability than each of the soft magnetic layers, the first soft magnetic layer corresponding to one of the soft magnetic layers being provided closest to the insulating barrier layer,
wherein each nonmagnetic metal layer has a thickness that allows the two adjacent soft magnetic layers to be magnetically coupled to each other and allows all the soft magnetic layers to be magnetized in the same direction.

2. The tunneling magnetic sensing element according to claim 1, wherein each nonmagnetic metal layer has an average thickness of 1 to 4 Å.

3. The tunneling magnetic sensing element according to claim 1, wherein each nonmagnetic metal layer is composed of at least one of Ti, V, Zr, Nb, Mo, Hf, Ta, and W.

4. The tunneling magnetic sensing element according to claim 3, wherein each nonmagnetic metal layer is composed of Ta.

5. The tunneling magnetic sensing element according to claim 1, wherein a total thickness obtained by adding the average thickness of the first soft magnetic layer and the average thickness of the enhancement layer is 25 to 80 Å.

6. The tunneling magnetic sensing element according to claim 1, wherein each soft magnetic layer has an average thickness of 10 to 30 Å.

7. The tunneling magnetic sensing element according to claim 1, wherein a total thickness obtained by adding the average thicknesses of the individual soft magnetic layers is 35 to 80 Å.

8. The tunneling magnetic sensing element according to claim 1, wherein the insulating barrier layer is composed of Ti—Mg—O.

9. The tunneling magnetic sensing element according to claim 1, wherein each soft magnetic layer is composed of a Ni—Fe alloy, and the enhancement layer is composed of a Co—Fe alloy.
